(19) United States
(12) Patent Application Publication
(10) Pub. No.: US 2025/0229613 A1
(43) Pub. Date: Jul. 17, 2025

(54) DOOR SYSTEM FOR A VEHICLE

(71) Applicant: GM Global Technology Operations LLC, Detroit, MI (US)

(72) Inventor: Darren M. Van Houzen, Shelby Twp, MI (US)

(21) Appl. No.: 18/413,329

(22) Filed: Jan. 16, 2024

(51) Int. Cl. B60J 10/79; B60J 10/18; B60J 10/26

(52) U.S. Cl. CPC B60J 10/79; B60J 10/18; B60J 10/26

(57) ABSTRACT

A door for a vehicle includes an outer panel and an inner panel connected to the outer panel. The door includes a window opening defined by the outer panel and the inner panel. A glass panel is supported between the outer panel and the inner panel at the window opening. The glass panel includes an inner glass surface and an outer glass surface. A molding support member extends outwardly relative to the inner panel substantially perpendicularly to the glass panel. A molding element connected to the molding support member. The molding element includes an outer surface. The molding support member positions the molding element relative to the glass panel creating an offset between the outer surface of the molding element relative to the outer glass surface of no more than 10 mm.

### INTRODUCTION

The subject disclosure relates to the art of door systems and, more particularly, to a door system for a vehicle.

Vehicles include a body that defines a passenger compartment that accommodates a driver, if needed, and passengers. The passenger compartment is typically accessed through one or more doors. Each door may include an opening that is closed by a window. The window may be retracted into the door when open, or raised to cover the opening when closed. The door includes an outer surface portion, an inner surface portion, and a structural portion. A window mechanism is arranged between the outer surface portion and the inner surface portion. Outer trim elements are typically mounted to the outer surface portion and inner trim elements are typically mounted to the inner surface portion. The outer trim elements, inner trim elements, and window form a stack-up that defines a thickness of the door at the opening.

Given the number of components that form the stack-up, outer glass surfaces of the windows often times do not sit flush with external body and/or door surfaces. Passenger vehicle doors are typically thinner than doors on a pick-up truck. In some cases, there is no structure about the opening in a passenger vehicle. The lack of a frame makes it easier to reduce window offset or the distance between the outer glass surface and the outer surface of surrounding components. The window offset on a pick-up truck is larger than that of a passenger vehicle as a result of various design constraints. To some individuals the window offset is aesthetically unappealing. The window offset may also contribute to aerodynamic inefficiencies for the vehicle. Accordingly, it is desirable to provide a system for forming a door, particularly for larger vehicles, with a reduced window offset.

### SUMMARY

A door for a vehicle, in accordance with a non-limiting example, includes an outer panel and an inner panel connected to the outer panel. The door includes a window opening defined by the outer panel and the inner panel. A glass panel is supported between the outer panel and the inner panel at the window opening. The glass panel includes an inner glass surface and an outer glass surface. A molding support member extends outwardly relative to the inner panel substantially perpendicularly to the glass panel. A molding element connected to the molding support member. The molding element includes an outer surface. The molding support member positions the molding element relative to the glass panel creating an offset between the outer surface of the molding element relative to the outer glass surface of no more than 10 mm.

In addition to one or more of the features described herein the molding support member positions the molding element relative to the glass panel creating an offset between the outer surface of the molding element relative to the outer glass surface of no more than 9 mm.

In addition to one or more of the features described herein the molding support member positions the molding element relative to the glass panel creating an offset between the outer surface of the molding element relative to the outer glass surface of no more than 8.8 mm.

In addition to one or more of the features described herein a window channel is fixedly connected to the outer panel and the inner panel, the molding support member being fixedly connected to the window channel.

In addition to one or more of the features described herein the window channel includes a first portion extending substantially perpendicularly relative to the glass panel and a second portion extending substantially perpendicularly relative to the glass panel, the first portion being joined to the outer panel and the second portion being joined to the inner panel.

In addition to one or more of the features described herein the molding support member is joined to the second portion of the window channel.

In addition to one or more of the features described herein the molding support member is welded to the second portion of the window channel.

In addition to one or more of the features described herein a molding support element is connected to the molding support member, the molding support element including a molding element connector connected to the molding element and a glass run seal, the glass run seal including a plurality of seal elements that engage the inner glass surface of the glass panel.

In addition to one or more of the features described herein the glass run seal is integrally formed with the molding support element and the molding element connector.

In addition to one or more of the features described herein the molding support element includes a molding support member interface including metal reinforcing member.

A vehicle, in accordance with a non-limiting example, includes a body defining, at least in part, a passenger compartment. The body includes an opening providing access to the passenger compartment. A door is pivotally mounted to the body at the opening. The door includes an outer panel and an inner panel connected to the outer panel. The door includes a window opening defined by the outer panel and the inner panel. A glass panel is supported between the outer panel and the inner panel at the window opening. The glass panel includes an inner glass surface and an outer glass surface. A molding support member extends outwardly relative to the inner panel substantially perpendicularly to the glass panel. A molding element is connected to the molding support member. The molding element includes an outer surface. The molding support member positions the molding element relative to the glass panel creating an offset between the outer surface of the molding element relative to the outer glass surface of no more than 10 mm.

In addition to one or more of the features described herein the molding support member positions the molding element relative to the glass panel creating an offset between the outer surface of the molding element relative to the outer glass surface of no more than 9 mm.

In addition to one or more of the features described herein the molding support member positions the molding element relative to the glass panel creating an offset between the outer surface of the molding element relative to the outer glass surface of no more than 9 mm.

In addition to one or more of the features described herein a window channel fixedly connected to the outer panel and the inner panel, the molding support member being fixedly connected to the window channel.

In addition to one or more of the features described herein the window channel includes a first portion extending substantially perpendicularly relative to the glass panel and a second portion extending substantially perpendicularly relative to the glass panel, the first portion being joined to the outer panel and the second portion being joined to the inner panel.

In addition to one or more of the features described herein the molding support member is joined to the second portion of the window channel.

In addition to one or more of the features described herein the molding support member is welded to the second portion of the window channel.

In addition to one or more of the features described herein a molding support element connected to the molding support member, the molding support element including a molding element connector connected to the molding element and a glass run seal, the glass run seal including a plurality of seal elements that engage the inner glass surface of the glass panel.

In addition to one or more of the features described herein the glass run seal is integrally formed with the molding support element and the molding element connector.

In addition to one or more of the features described herein the molding support element includes a molding support member interface including metal reinforcing member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle shown in the form of a pick-up truck having a door including a door trim system, in accordance with a non-limiting example;

FIG. 2 is a partial cross-sectional view of the door of FIG. 1 taken through the line 2-2, in accordance with a non-limiting example; and

FIG. 3 is a detail view of the door trim system of the door of FIG. 2, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

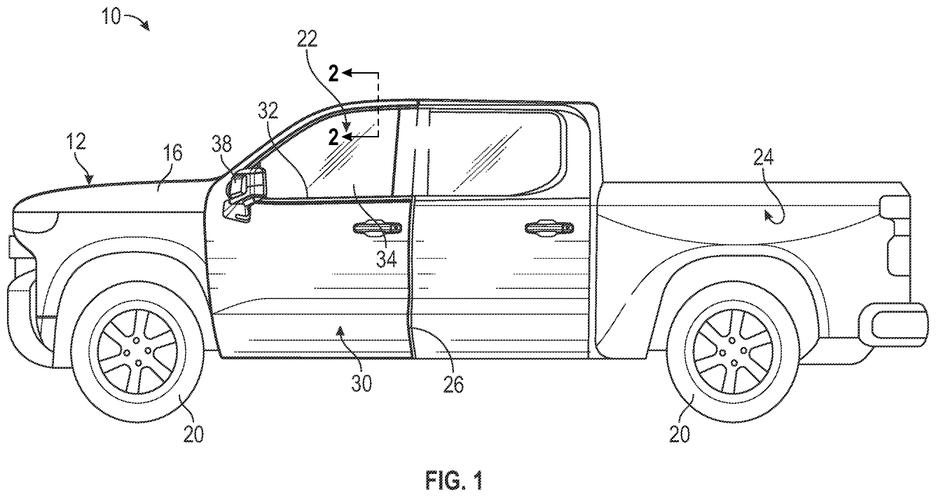

A vehicle, in accordance with a non-limiting example, is indicated generally at 10 in FIG. 1. Vehicle 10 takes the form of a pickup truck 12 having a body 16 supported on a plurality of wheels, two of which are indicated at 20. Body 16 defines a passenger compartment 22 and a cargo bed 24. Body 16 includes an opening 26 that provides access to passenger compartment 22. A door 30 is pivotally mounted to body 16 at opening 26. Door 30 selectively facilitates egress from and ingress into passenger compartment 22. The number of openings and corresponding doors provided on body 16 may vary.

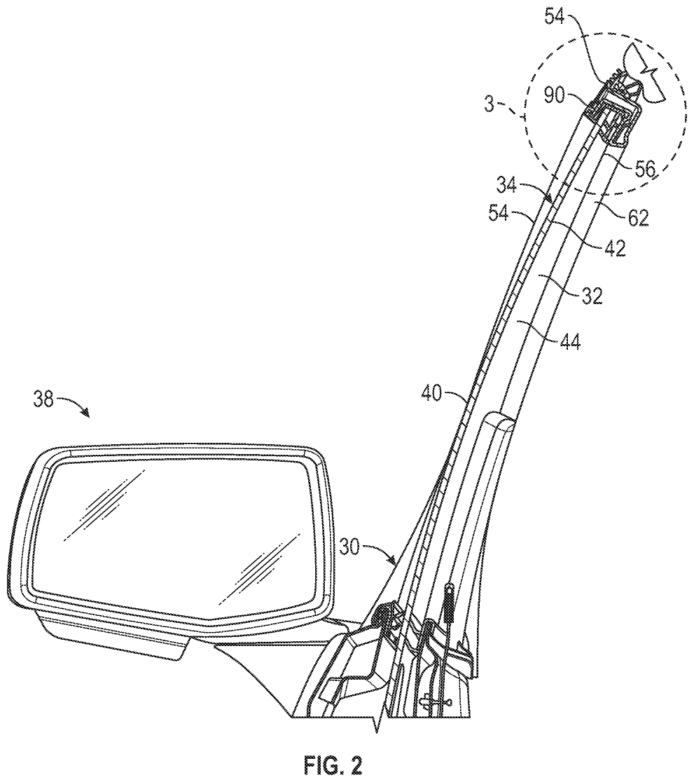

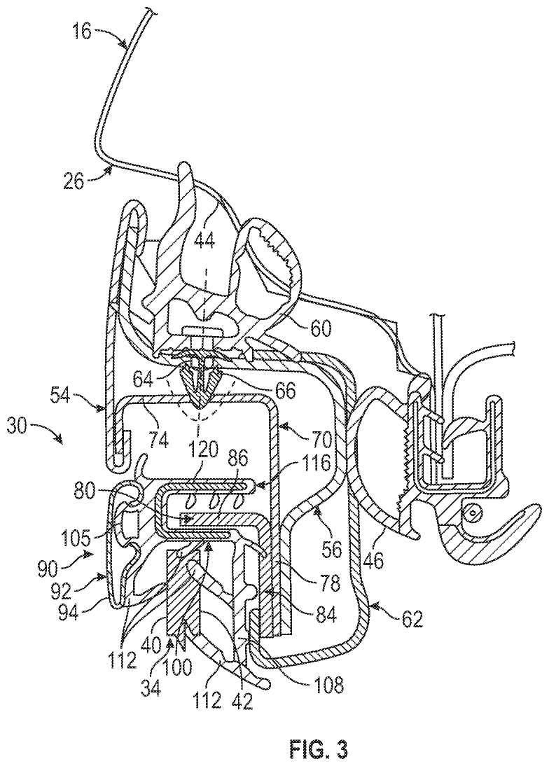

In a non-limiting example, door 30 includes a window opening 32 that is selectively covered by a glass panel or window 34. A side view mirror 38 is mounted to door 30 adjacent to window opening 32. Referring to FIGS. 2 and 3, window 34 includes an outer glass surface 40 and an inner glass surface 42. Opening 26 includes a peripheral surface 44 supporting an inner door seal 46. Door 30 includes an outer panel 54 that may be decorative and an inner panel 56 that may be structural. A door seal 60 may be connected to inner panel 56. Door seal 60 provides a perimetrical seal about door 30. Garnish trim 62 is mounted to inner panel 56. Garnish trim 62 provides an aesthetic finish to door 30. Inner panel 56 and garnish trim 62 may include an opening 64 that receives a connector 66 that secures door seal 60 to door 30.

In a non-limiting example, a window channel 70 is supported between outer panel 54 and inner panel 56. Window channel 70 includes a first portion 74 that extends substantially perpendicularly to window 34 and a second portion 78 that extends substantially parallel to window 34. First portion 74 is connected to outer panel 54 and second portion 78 is connected to inner panel 56. For example, first portion 74 may be connected to outer panel 54 through a hem seam (not separately labeled) and second portion 78 is connected to inner panel 58 through a welded joint (also not separately labeled).

In a non-limiting example, a molding support member 80 projects substantially perpendicularly relative to window 35. In the non-limiting example shown in FIG. 3, molding support member 80 includes a first section 84 that is secured to second portion 78 of window channel 70 and a second section 86 that projects substantially perpendicularly relative to window 34. In a non-limiting example, a molding element 90 is connected to molding support member 80. Molding element 90 takes the form of reveal molding 92 having an outer surface 94. In a non-limiting example, molding element 90 is connected to molding support member 80 through a molding support element 100.

In a non-limiting example, molding support element 100 includes a molding element connector 105 that couples molding element 90 to molding support member 80 and a glass run seal 108 having a plurality of seal elements 112 that engage outer and inner glass surfaces 40 and 42 of window 34. Seal elements 112 prevent moisture from entering passenger compartment 22 when window 34 is closed. In a non-limiting example, molding support element 100 includes a molding support member interface 116 having a metal reinforcing member 120. Molding support member interface 116 secures molding support element 100 to molding support member 80.

In a non-limiting example, by securing molding support member 80 to window channel 70 so as to extend substantially perpendicularly relative to window 34, a stack thickness may be achieved that ensures that outer glass surface 40 of window 34 is offset relative to outer surface 94 of molding element 90 no more than 10-mm. In another non-limiting example, the particular design and geometry of molding support member 80 ensures that outer glass surface 40 of window 34 is offset relative to outer surface 94 of molding element 90 by no more than 9-mm. In yet another non-limiting example, the particular design and geometry of molding support member 80 ensures that outer glass surface 40 of window 34 is offset relative to outer surface 94 of molding element 90 no more than 8.8-mm.

At this point, it should be understood that the particular geometry of molding support member 80 may vary. That is, molding support member 80 need not include two separate sections. Further, it should be understood that by reducing the offset of outer glass surface 40 of window 34 relative to the outer surface of molding element 90 not only are aesthetic preferences met but vehicle aerodynamics may be enhanced by reducing tripping surfaces at window opening 26.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A door for a vehicle comprising:
an outer panel;
an inner panel connected to the outer panel, the door including a window opening defined by the outer panel and the inner panel;
a glass panel supported between the outer panel and the inner panel at the window opening, the glass panel including an inner glass surface and an outer glass surface;
a molding support member that extends outwardly relative to the inner panel substantially perpendicularly to the glass panel; and
a molding element connected to the molding support member, the molding element including an outer surface, wherein the molding support member positions the molding element relative to the glass panel creating an offset between the outer surface of the molding element relative to the outer glass surface of no more than 10 mm.

2. The door according to claim 1, wherein the molding support member positions the molding element relative to the glass panel creating an offset between the outer surface of the molding element relative to the outer glass surface of no more than 9 mm.

3. The door according to claim 1, wherein the molding support member positions the molding element relative to the glass panel creating an offset between the outer surface of the molding element relative to the outer glass surface of no more than 8.8 mm.

4. The door according to claim 1, further comprising: a window channel fixedly connected to the outer panel and the inner panel, the molding support member being fixedly connected to the window channel.

5. The door according to claim 4, wherein the window channel includes a first portion extending substantially perpendicularly relative to the glass panel and a second portion extending substantially perpendicularly relative to the glass panel, the first portion being joined to the outer panel and the second portion being joined to the inner panel.

6. The door according to claim 5, wherein the molding support member is joined to the second portion of the window channel.

7. The door according to claim 6, wherein the molding support member is welded to the second portion of the window channel.

8. The door according to claim 1, further comprising a molding support element connected to the molding support member, the molding support element including a molding element connector connected to the molding element and a glass run seal, the glass run seal including a plurality of seal elements that engage the inner glass surface of the glass panel.

9. The door according to claim 8, wherein the glass run seal is integrally formed with the molding support element and the molding element connector.

10. The door according to claim 9, wherein the molding support element includes a molding support member interface including metal reinforcing member.

11. A vehicle comprising:
a body defining, at least in part, a passenger compartment, the body including an opening providing access to the passenger compartment; and
a door pivotally mounted to the body at the opening, the door comprising:
an outer panel;
an inner panel connected to the outer panel, the door including a window opening defined by the outer panel and the inner panel;
a glass panel supported between the outer panel and the inner panel at the window opening, the glass panel including an inner glass surface and an outer glass surface;
a molding support member that extends outwardly relative to the inner panel substantially perpendicularly to the glass panel; and
a molding element connected to the molding support member, the molding element including an outer surface, wherein the molding support member positions the molding element relative to the glass panel creating an offset between the outer surface of the molding element relative to the outer glass surface of no more than 10 mm.

12. The vehicle according to claim 11, wherein the molding support member positions the molding element relative to the glass panel creating an offset between the outer surface of the molding element relative to the outer glass surface of no more than 9 mm.

13. The vehicle according to claim 1, wherein the molding support member positions the molding element relative to the glass panel creating an offset between the outer surface of the molding element relative to the outer glass surface of no more than 9 mm.

14. The vehicle according to claim 11, further comprising a window channel fixedly connected to the outer panel and the inner panel, the molding support member being fixedly connected to the window channel.

15. The vehicle according to claim 14, wherein the window channel includes a first portion extending substantially perpendicularly relative to the glass panel and a second portion extending substantially perpendicularly relative to the glass panel, the first portion being joined to the outer panel and the second portion being joined to the inner panel.

16. The vehicle according to claim 15, wherein the molding support member is joined to the second portion of the window channel.

17. The vehicle according to claim 16, wherein the molding support member is welded to the second portion of the window channel.

18. The vehicle according to claim 11, further comprising a molding support element connected to the molding support member, the molding support element including a molding element connector connected to the molding element and a glass run seal, the glass run seal including a plurality of seal elements that engage the inner glass surface of the glass panel.

19. The vehicle according to claim 18, wherein the glass run seal is integrally formed with the molding support element and the molding element connector.

20. The vehicle according to claim 19, wherein the molding support element includes a molding support member interface including metal reinforcing member.
